(19) United States
(12) Patent Application Publication
(10) Pub. No.: US 2026/0296181 A1
(43) Pub. Date: Oct. 1, 2026

(54) ELECTRIC VEHICLE

(71) Applicant: TOYOTA JIDOSHA KABUSHIKI KAISHA, Aichi-ken (JP)

(72) Inventor: Shinichiro IHORI, Toki-shi (JP)

(21) Appl. No.: 19/358,425

(22) Filed: Oct. 15, 2025

(30) Foreign Application Priority Data
Mar. 26, 2025 (JP) 2025-051838

(51) Int. Cl. B60K 15/07; B60K 15/03; B60K 15/063; B60K 15/067; B60L 50/75

(52) U.S. Cl. CPC B60K 15/07; B60L 50/75; B60K 2015/03315; B60K 2015/0639; B60K 2015/0675; B60L 2200/18

(57) ABSTRACT

An electric vehicle comprising: left and right side rails mounted on a roof; and first to third hydrogen tanks which are cylindrical longitudinal members and in which nozzles at both ends in a longitudinal direction are fastened to the left and right side rails, wherein the left and right side rails include left and right fragile portions in which a load-bearing capacity in a vehicle longitudinal direction is equal to or less than a load-bearing capacity of the first to third hydrogen tanks.

### CROSS REFERENCE TO RELATED APPLICATION

This application claims priority to Japanese Patent Application No. 2025-051838 filed on Mar. 26, 2025, which is incorporated herein by reference in its entirety including the specification, claims, drawings, and abstract.

### TECHNICAL FIELD

The present disclosure relates to a structure of an electric vehicle comprising a gas fuel tank on a roof.

### BACKGROUND

In JP2006-188170A, an electric vehicle in which a gas fuel tank is mounted on a roof is disclosed.

### SUMMARY

In the case of a frontal collision of the electric vehicle described in JP2006-188170A, the impact energy is absorbed by the body of the vehicle, and the impact force often does not reach the gas fuel tank disposed on the roof. However, in a case where an obstacle does not collide with the body of the vehicle and enters the roof so as to squeeze the upper portion of the roof, there is a possibility that an impact force may be exerted on the gas fuel tank disposed on the roof due to the entry of the obstacle.

Accordingly, an object of the present disclosure is to suppress damage to a gas fuel tank disposed on a roof due to entry of an obstacle.

An electric vehicle according to an embodiment of the present disclosure includes: left and right side rails mounted on a roof and extending in the vehicle front-rear direction, at least one gas fuel tank that is a cylindrical longitudinal member and is fastened to the left and right side rails at both ends in a longitudinal direction thereof, each of the left and right side rails includes at least one fragile portion in which a load-bearing capacity in the vehicle front-rear direction is equal to or less than a load-bearing capacity of the gas fuel tank.

As described above, by providing the side rail with the fragile portion in which the load resistance is equal to or less than the load resistance of the gas fuel tank, when the impact force is applied to the gas fuel tank, the fragile portion breaks or deforms, and the gas fuel tank moves rearward. Accordingly, it is possible to suppress a large impact force from being applied to the gas fuel tank, and it is possible to suppress damage to the gas fuel tank due to entry of an obstacle.

In the electric vehicle according to the present disclosure, each of the left and right side rails may include at least one tank fastening portion to which an end portion of the gas fuel tank may be fastened, the fragile portion may be provided at one or both of a front side and a rear side of the tank fastening portion, the load-bearing capacity of the fragile portion in the vehicle front-rear direction may be equal to or less than half of the load-bearing capacity of the trunk portion of the gas fuel tank in the radial direction and equal to or less than the load-bearing capacity of the end portion of the gas fuel tank.

Accordingly, when a collision load is applied to the gas fuel tank, the fragile portion of the gas fuel tank breaks or deforms earlier than the body portion or the end portion thereof, and the gas fuel tank can move rearward. Accordingly, damage to the gas fuel tank can be suppressed.

The electric vehicle according to the present disclosure may further include left and right base rails mounted on a roof and extending in a vehicle front-rear direction, wherein the left and right side rails may be disposed on upper surfaces of the left and right base rails, and the left and right tank fastening portions may be fixed at a fixing portion on upper surfaces of the left and right base rails, a load-bearing capacity of the fixing portion in the vehicle front-rear direction may be equal to or less than half of a load-bearing capacity of the trunk portion of the gas fuel tank in the radial direction and equal to or less than a load-bearing capacity of the gas fuel tank in the end portion.

Accordingly, when a collision load is applied to the gas fuel tank, the fixed portion breaks earlier than the trunk portion or the end portion of the gas fuel tank, and thus the gas fuel tank can move rearward together with the tank fastening portion. Accordingly, damage to the gas fuel tank can be suppressed.

In the electric vehicle according to the present disclosure, each of the fixing portions may include a plurality of welding beads, and a total of load-bearing capacities of the plurality of weld beads in the vehicle front-rear direction mat be equal to or less than half of a load-bearing capacity of the trunk portion of the gas fuel tank in the radial direction and equal to or less than a load-bearing capacity of the end portion of the gas fuel tank.

Accordingly, when a collision load is applied to the gas fuel tank, the plurality of weld beads break, and the tank fastening portion can move rearward together with the gas fuel tank. Accordingly, damage to the gas fuel tank can be suppressed.

The electric vehicle according to the present disclosure may further include a plurality of brackets fixed to an upper surface of each of the left and right side rails by a plurality of fastening members, each of the plurality of brackets covering each of the fragile portions, wherein each of the plurality of the fastening members is rupturable upon impact.

As a result, the strength of the fragile portion in a normal state can be maintained, and the fragile portion can be easily broken by breaking the fastening member and detaching the bracket at the time of collision.

In the electric vehicle according to the present disclosure, the at least one gas fuel tank may include a plurality of gas fuel tanks, and a length of each of the at least one fragile portion in the vehicle front-rear direction is longer than a gap between the plurality of gas fuel tanks in the vehicle front-rear direction.

Accordingly, when the fragile portion is crushed in the front-rear direction at the time of collision, the gas fuel tank can be moved rearward in the ball-pushed state and can be detached from the base rail.

The present disclosure can suppress damage to a gas fuel tank disposed on a roof due to entry of an obstacle.

### BRIEF DESCRIPTION OF DRAWINGS

FIG. 1 is a side view of an electric vehicle according to an embodiment;

FIG. 2 is a plan view of a power generation unit mounted on the electric vehicle shown in FIG. 1;

FIG. 3 is a side view of the power generation unit shown in FIG. 2;

FIG. 4 is a detailed plan view of a mounting portion of a hydrogen tank of the power generation unit shown in FIG. 1, and is a detailed view of a portion A shown in FIG. 2;

FIG. 5 is a detailed elevation view of a mounting portion of a hydrogen tank of the power generation unit shown in FIG. 1, showing a right side surface of the power generation unit;

FIG. 6 is a cross-sectional view of the power generation unit shown in FIG. 1, and is a cross-sectional view taken along line B-B of FIG. 4;

FIG. 7 is an explanatory view showing entry of a barrier into the power generation unit shown in FIG. 1, and is a view showing a state in which the barrier collides with a front end of the power generation unit;

FIG. 8 is an explanatory view showing the entry of the barrier into the power generation unit shown in FIG. 1, showing a state in which the FC module collides with the first hydrogen tank due to the entry of the barrier.

FIG. 9 is an explanatory view showing the entry of the barrier into the power generation unit shown in FIG. 1, showing a state in which the first hydrogen tank collides with the second hydrogen tank due to the entry of the barrier.

FIG. 10 is an explanatory view showing the entry of the barrier into the power generation unit shown in FIG. 1, showing a state in which the second hydrogen tank collides with the third hydrogen tank due to the entry of the barrier.

FIG. 11 is an explanatory view showing the entry of the barrier into the power generation unit shown in FIG. 1, showing a state in which the first to third hydrogen tanks are separated from the rear base rail by the entry of the barrier.

### DESCRIPTION OF EMBODIMENTS

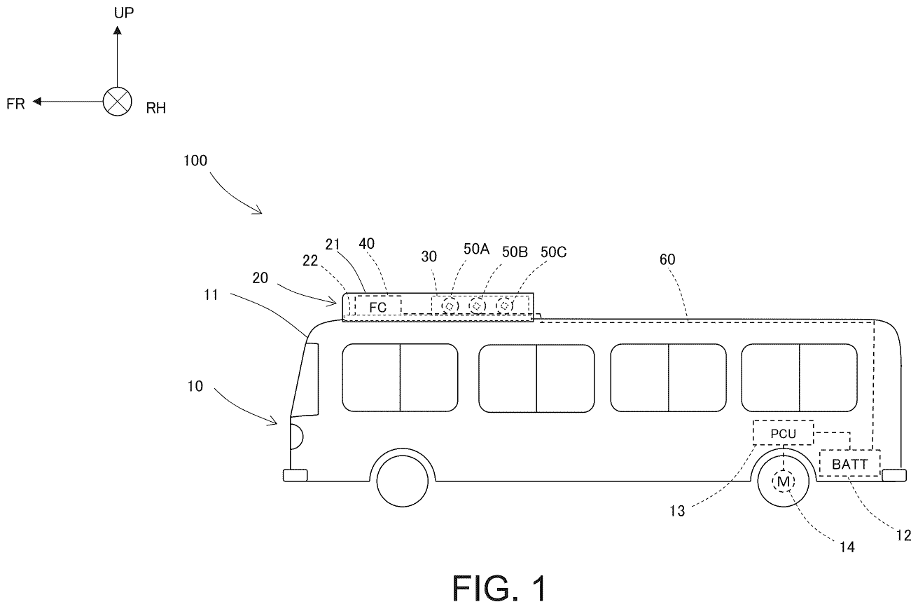

Hereinafter, an electric vehicle 100 according to an embodiment will be described with reference to the drawings. As shown in FIG. 1, an electric vehicle 100 includes a body 10, a power generation unit 20, a high-voltage battery 12, a power control device (hereinafter referred to as a PCU) 13, and a driving motor 14. In the following description, the electric vehicle 100 will be described as an electric bus. Note that FR, UP, and RH shown in the drawings indicate a front side, an upper side, and a right side of the electric vehicle 100, respectively. The opposite directions of FR, UP, and RH indicate the rear side, the lower side, and the left side, respectively. Hereinafter, in the case where the front-rear direction, the left-right direction, and the up-down direction are simply used, the front-rear direction, the left-right direction, and the up-down direction of the electric vehicle 100 are indicated unless otherwise specified.

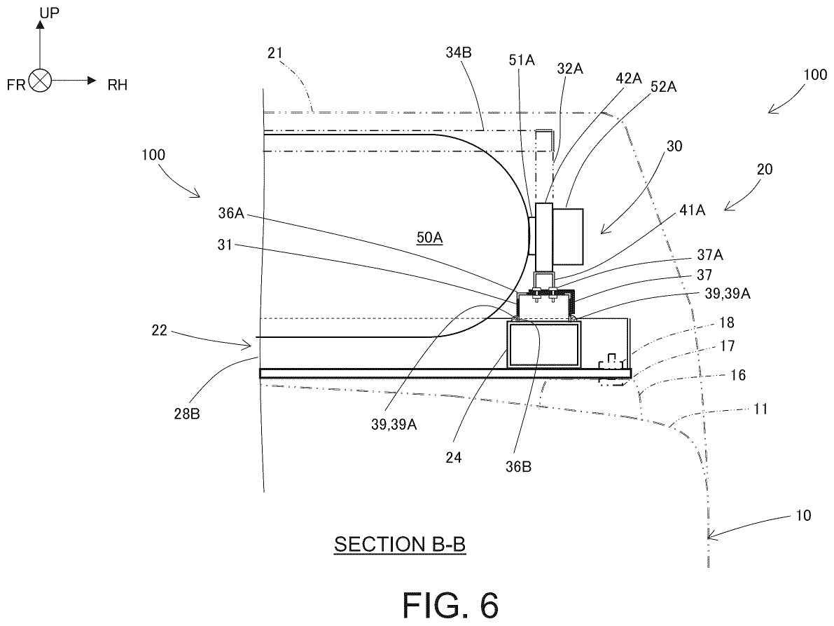

As shown in FIG. 1, the power generation unit 20 includes a base frame 22, a frame 30, an FC module 40, first to third hydrogen tanks 50A, 50B, and 50C, and a casing 21. The base frame 22 is fixed on the roof 11 by a mounting rail 16 (see FIG. 6). The frame 30 is mounted on the base frame 22. The FC module 40 is mounted on the base frame 22. The first to third hydrogen tanks 50A, 50B, and 50C are mounted in the frame 30. The power generation unit 20 is covered by a casing 21.

The first to third hydrogen tanks 50A, 50B, and 50C are gas fuel tanks that store hydrogen gas as gas fuel. The FC module 40 is a fuel cell module that generates power using hydrogen gas supplied from the first to third hydrogen tanks 50A, 50B, and 50C as fuel. The electric power generated by the FC module 40 charges the high-voltage battery 12 at the rear portion of the electric vehicle 100 by the high-voltage cable 60, and is supplied from the PCU 13 to the driving motor 14. The driving motor 14 drives wheels to drive the electric vehicle 100.

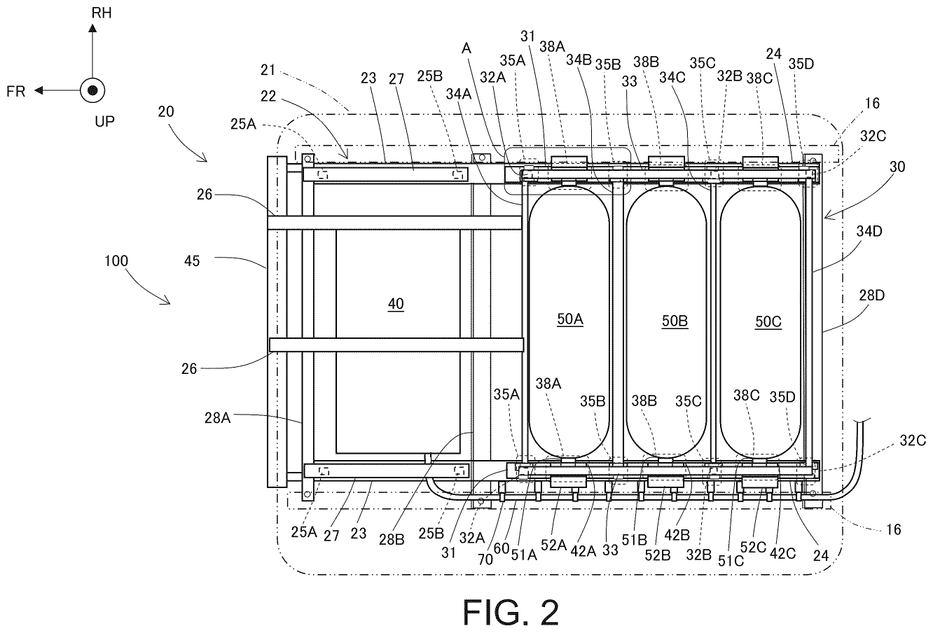

Next, the structure of the power generation unit 20 will be described with reference to FIGS. 2 to 6. As shown in FIGS. 2 to 6, the base frame 22 includes left and right front base rails 23, left and right rear base rails 24, first to fourth cross members 28A to 28D, left and right first and second columns 25A and 25B, left and right front upper rails 27, and an upper connecting member 26.

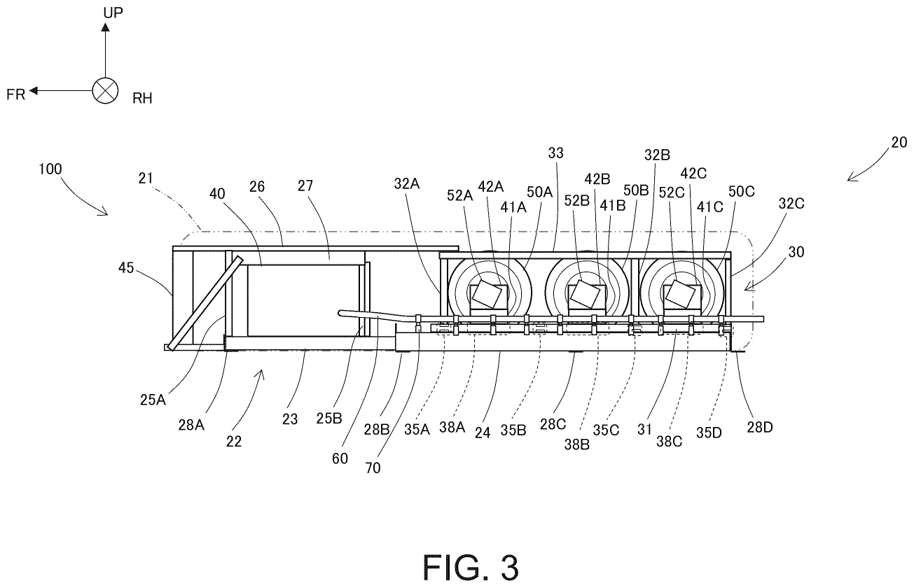

As shown in FIGS. 2 and 3, the left and right front base rails 23 and the left and right rear base rails 24 are connected to each other in the vehicle front-rear direction. The rear base rail 24 is higher than the front base rail 23. As shown in FIG. 6, the rear base rail 24 is a quadrangular closed cross-sectional member. Similarly to the rear base rail 24, the front base rail 23 is also a quadrangular closed cross-sectional member.

As shown in FIGS. 2 and 3, the first cross member 28A is an L-shaped cross-sectional member that connects the left and right front base rails 23 in the vehicle width direction. The second cross member 28B is an L-shaped cross-sectional member that connects the front end of the rear base rail 24 and the rear end of the front base rail 23 in the vehicle width direction. The third and fourth cross members 28C and 28D are L-shaped cross-sectional members that connect the center and the rear end of the rear base rail 24 in the vehicle width direction. The left and right front base rails 23, the left and right rear base rails 24, and the first to fourth cross members 28A to 28D constitute a square grid frame. As shown in FIG. 6, left and right mounting rails 16 are fixed on the roof 11, and left and right end portions of the first to fourth cross members 28A to 28D are fixed to the left and right mounting rails 16 by bolts 17 and nuts 18.

As shown in FIGS. 2 and 3, the left and right first and second columns 25A and 25B are erected on the front end portion and the rear end portion of the left and right front base rails 23. The upper ends of the first and second columns 25A and 25B are connected by left and right front upper rails 27. The two upper connecting members 26 connect the first upper cross member 34A of the frame 30 described later and the upper portion of the radiator 45 to each other in the vehicle front-rear direction.

As shown in FIGS. 2 and 3, the frame 30 includes left and right side rails 31, left and right first to third frame columns 32A, 32B, and 32C, left and right upper side rails 33, and first to fourth upper cross members 34A, 34B, 34C and 34D.

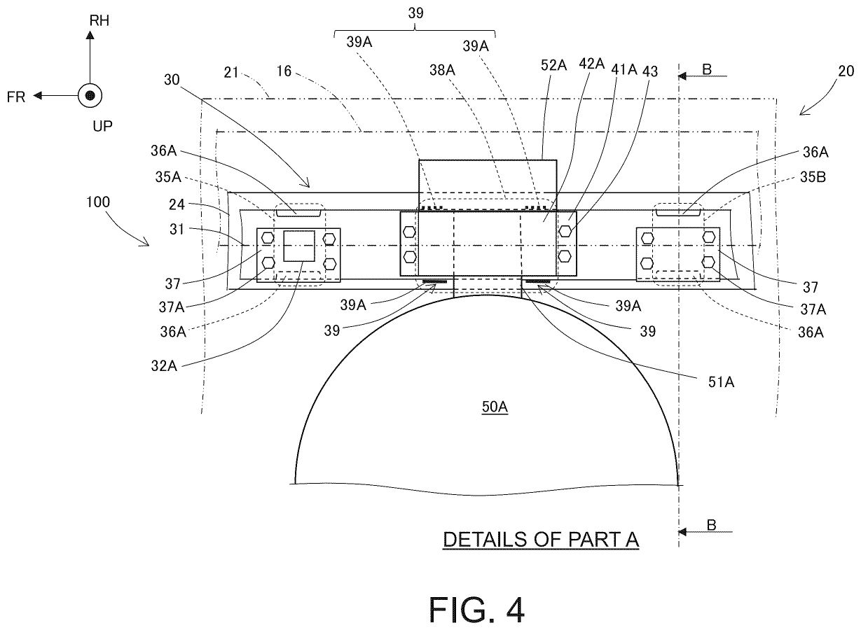

The left and right side rails 31 are fixed to the left and right rear base rails 24 by welding. The detailed structure of the left and right side rails 31 will be described later with reference to FIGS. 4 to 6. The left and right first to third frame columns 32A, 32B, and 32C are erected on the front portion, the center portion, and the rear portion of the left and right side rails 31. Upper ends of the left and right first to third frame columns 32A, 32B, and 32C are connected to the left and right upper side rails 33 in the front-rear direction. The first to fourth upper cross members 34A, 34B, 34C and 34D connect the left and right upper side rails 33.

As shown in FIGS. 2 and 3, an FC module 40 is mounted in a region surrounded by the left and right front base rails 23 and the first and second cross members 28A and 28B. A radiator 45 is mounted in front of the left and right front base rails 23. First to third hydrogen tanks 50A, 50B, and 50C are mounted on the left and right side rails 31 of the frame 30 so that the longitudinal direction is the vehicle width direction.

As shown in FIGS. 2 and 4 to 6, the first hydrogen tank 50A is a cylindrical elongated member having hemispherical end plates attached to both ends thereof. Left and right nozzles 51A protruding in the longitudinal direction are attached to the centers of the end plates at both ends. The left and right nozzles 51A constitute end portions in the longitudinal direction of the first hydrogen tank 50A. The nozzle 51A communicates with the inside of the first hydrogen tank 50A. A valve unit 52A is attached to a longitudinal end of the nozzle 51A. The hydrogen gas stored in the first hydrogen tank 50A is supplied to the FC module 40 through the nozzle 51A and the valve unit 52A. The hydrogen gas is filled into the first hydrogen tank 50A through the valve unit 52A and the nozzle 51A.

As shown in FIGS. 3 and 4 to 6, left and right pedestals 41A are fixed to upper portions of the left and right side rails 31 by bolts 43. Left and right fixing clamps 42A for fixing the left and right nozzles 51A of the first hydrogen tank 50A by bolts (not shown) are mounted on the left and right pedestals 41A. The first hydrogen tank 50A is fixed to the front portions of the left and right side rails 31 by fixing the left and right nozzles 51A to the left and right fixing clamps 42A. As described above, the left and right nozzles 51A of the first hydrogen tank 50A (both end portions of the first hydrogen tank 50A) are fastened to the front portions of the left and right side rails 31 by the left and right fixing clamps 42A and the left and right pedestals 41A. Portions of the left and right side rails 31 to which the left and right pedestals 41A are fastened constitute left and right first tank fastening portions 38A. The left and right first tank fastening portions 38A are fixed to the front portion of the rear base rail 24 by a plurality of weld beads 39A. The plurality of weld beads 39A also constitute the weld portion 39. The welded portion 39 is a fixing portion for fixing the left and right first tank fastening portions 38A to the rear base rail 24.

Similarly, as shown in FIGS. 2 and 3, the second and third hydrogen tanks 50B and 50C include left and right nozzles 51B and 51C, and left and right valve units 52B and 52C are attached to longitudinal ends of the left and right nozzles 51B and 51C. The left and right nozzles 51B and 51C of the second and third hydrogen tanks 50B and 50C are fastened to the center portion and the rear portion of the left and right side rails 31 by the left and right fixing clamps 42B and 42C and the left and right pedestals 41B and 41C. Portions of the side rail 31 to which the left and right pedestals 41B and 41C are fastened constitute left and right second and third tank fastening portions 38B and 38C of the side rail 31. The left and right second and third tank fastening portions 38B and 38C are fixed to the central portion and the rear portion of the rear base rail 24 by a plurality of weld beads 39A.

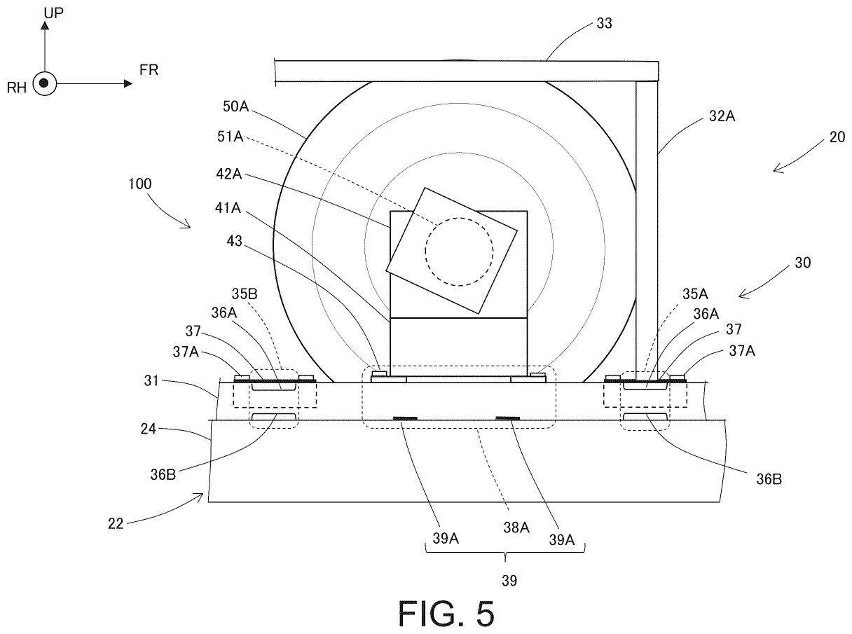

As shown in FIGS. 2 and 3, a first fragile portion 35A and a second fragile portion 35B are provided on the front and rear sides of the first tank fastening portion 38A of the left and right side rails 31. As shown in FIGS. 4 and 5, the first fragile portion 35A is provided with an upper notch 36A and a lower notch 36B, and has a smaller cross-sectional area than a general portion of the side rail 31. Here, the upper notch 36A is a portion obtained by cutting out an upper ridge line portion of the groove-shaped side rail 31 into an elongated hole shape elongated in the front-rear direction. The lower notch 36B is a portion in which a lower end portion is cut out in a half-elongated hole shape elongated in the front-rear direction. The lengths of the upper notch 36A and the lower notch 36B in the front-rear direction can be freely set, but may be longer than the gap between the first hydrogen tank 50A and the second hydrogen tank 50B in the front-rear direction, similarly to the second fragile portion 35B described later.

A bracket 37 is attached to the upper surface of the first fragile portion 35A so as to cover the upper notch 36A. The bracket 37 is an L-shaped member whose length in the front-rear direction is longer than the length in the front-rear direction of the upper notch 36A, and is fixed to the upper surface of the side rail 31 on the front and rear sides of the upper notch 36A by bolts 37A which are fastening members. In this way, the bracket 37 connects the front side and the rear side of the upper notch 36A to compensate for the loss of the cross section due to the upper notch 36A and the lower notch 36B. The first frame column 32A is attached to the upper surface of the bracket 37 of the first fragile portion 35A.

The second fragile portion 35B has the same configuration as that of the first fragile portion 35A, but a pillar is not provided on the upper surface of the bracket 37. The second fragile portion 35B is disposed in front of the second tank fastening portion 38B. The lengths of the upper notch 36A and the lower notch 36B of the second fragile portion 35B in the front-rear direction are longer than the gap between the first hydrogen tank 50A and the second hydrogen tank 50B in the front-rear direction. That is, the length of the second fragile portion 35B in the front-rear direction is longer than the gap between the first hydrogen tank 50A and the second hydrogen tank 50B in the front-rear direction.

As shown in FIGS. 2 and 3, a third fragile portion 35C is provided behind the second tank fastening portion 38B of the left and right side rails 31. The configuration of the third fragile portion 35C is the same as the configuration of the first fragile portion 35A, and the second frame column 32B is attached to the upper surface of the bracket 37. Similarly to the second fragile portion 35B, the length of the upper notch 36A and the lower notch 36B of the third fragile portion 35C in the front-rear direction is longer than the gap between the second hydrogen tank 50B and the third hydrogen tank 50C in the front-rear direction. That is, the length of the third fragile portion 35C in the front-rear direction is longer than the gap between the second hydrogen tank 50B and the third hydrogen tank 50C in the front-rear direction. A fourth fragile portion 35D is provided behind the third tank fastening portion 38C. The configuration of the fourth fragile portion 35D is the same as the configuration of the first fragile portion 35A, and the third frame column 32C is attached to the upper surface of the bracket 37.

As described above, the first fragile portion 35A and the second fragile portion 35B are provided on the front side and the rear side of the first tank fastening portion 38A. A second fragile portion 35B and a third fragile portion 35C are provided on the front and rear sides of the second tank fastening portion 38B. A third fragile portion 35C and a fourth fragile portion 35D are provided on the front and rear sides of the third tank fastening portion 38C. The lengths of the second fragile portion 35B and the third fragile portion 35C in the front-rear direction are longer than the gaps in the front-rear direction of the first and second hydrogen tanks 50A and 50B and the gaps in the front-rear direction of the second and third hydrogen tanks 50B and 50C.

Here, the load-bearing capacity FL of the first to fourth fragile portions 35A to 35D, the load-bearing capacity FW of the welded portion 39 between the first to third tank fastening portions 38A to 38C and the rear base rail 24, and the strength of the bolt 37A for fixing the bracket 37 will be described.

First, the load-bearing capacity FL of the first to fourth fragile portions 35A to 35D will be described. The load-bearing capacity FL of the first fragile portion 35A in the vehicle front-rear direction is equal to or less than a half of the load-bearing capacity GR in the radial direction of the trunk portion of the first hydrogen tank 50A and equal to or less than the load-bearing capacity GN of the nozzle 51A at the end portion in the longitudinal direction of the first hydrogen tank 50A.

The load-bearing capacity FL of the first fragile portion 35A in the vehicle front-rear direction is, for example, a load at which the first fragile portion 35A is greatly deformed by a load in the vehicle front-rear direction. For example, it is a breaking load of the first fragile portion 35A in the front-rear direction or a buckling load by which the first fragile portion 35A buckles and deforms in the front-rear direction.

The load-bearing capacity GR in the radial direction of the trunk portion of the first hydrogen tank 50A is a load that does not cause large compression deformation of the trunk portion when the cylindrical trunk portion of the first hydrogen tank 50A is compressed in the radial direction. For example, the radial load may be such that the maximum stress of the body reaches the allowable stress of the material of the body. Here, in the first hydrogen tank 50A, the left and right nozzles 51A are fastened to the left and right side rails 31 via the left and right fixing clamps 42A and the pedestals 41A. Therefore, half of the radial load applied to the first hydrogen tank 50A is applied to the first fragile portions 35A of the left and right side rails 31. Therefore, since the left and right first fragile portions 35A break or deform greatly before large deformation occurs in the first hydrogen tank 50A, the load-bearing capacity FL of the first fragile portions 35A is set to be half or less of the load-bearing capacity GR in the radial direction of the trunk portion of the first hydrogen tank 50A.

The load-bearing capacity GN of the nozzle 51A is a load at which the nozzle 51A does not deform significantly when a force in the radial direction of the first hydrogen tank 50A is applied to the nozzle 51A. For example, when a force in the radial direction is applied from the fixing clamp 42A to the nozzle 51A, the load may be such that the stress of the connection portion between the nozzle 51A and the end plate of the first hydrogen tank 50A reaches the allowable stress of the nozzle 51 or the material constituting the first hydrogen tank 50A.

In addition, the load-bearing capacity GR in the radial direction of the trunk portions of the second and third hydrogen tanks 50B and 50C and the load-bearing capacity GN of the nozzles 51B and 51C are the same as the load-bearing capacity GR of the first hydrogen tank 50A and the load resistance of the nozzle 51A, and the load-bearing capacity FL of the second to fourth fragile portions 35B to 35D is also the same as the load-bearing capacity FL of the first fragile portion 35A.

Next, the load-bearing capacity FW of the welded portion 39 between the first to third tank fastening portions 38A to 38C and the rear base rail 24 will be described. Similarly to the first to fourth fragile portions 35A to 35D, the load-bearing capacity FW of the welded portion 39 between the first to third tank fastening portions 38A to 38C and the rear base rail 24 is equal to or less than half of the load-bearing capacity GR in the radial direction of the trunk portion of the first hydrogen tank 50A and equal to or less than the load-bearing capacity GN of the nozzle 51A at the end portion in the longitudinal direction of the first hydrogen tank 50A. Accordingly, the welded portion 39 can be broken before the first to third hydrogen tanks 50A to 50C are largely deformed.

As described above, the weld portion 39 is configured by a plurality of weld beads 39A that connect the first tank fastening portion 38A and the rear base rail 24. Therefore, the load-bearing capacity FW of the welded portion 39 is the total load-bearing capacity in the vehicle longitudinal direction load of each weld bead 39A. Here, the load-bearing capacity of the weld bead 39A may be a breaking load of the weld bead 39A.

Next, the strength of the bolt 37A, which is a fastening member for fixing the bracket 37 to the side rail 31, will be described. The strength of the bolt 37A only needs to be rupturable when the electric vehicle 100 collides. For example, the breaking load may be set to be smaller than the withstand load of the bracket 37, and the bolt 37A may be cut when a bending moment is input to the bracket 37 from the first frame column 32A.

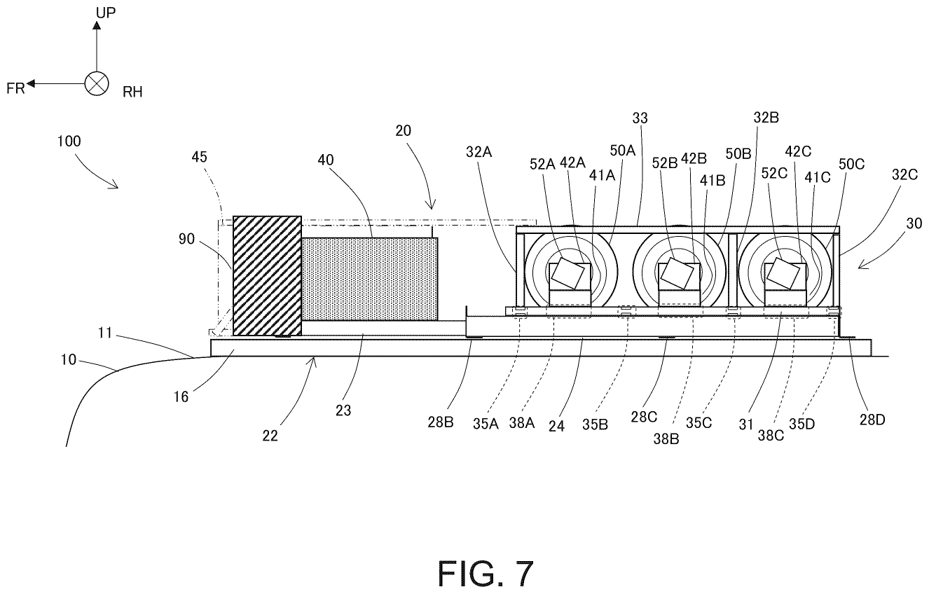

Next, with reference to FIGS. 7 to 11, deformation of each part when the barrier 90, which is an obstacle, enters the electric vehicle 100 configured as described above will be described. In the following description, as shown in FIG. 7, it is assumed that the barrier 90 does not collide with the body 10 of the electric vehicle 100 and enters the roof 11 so as to graze the roof 11.

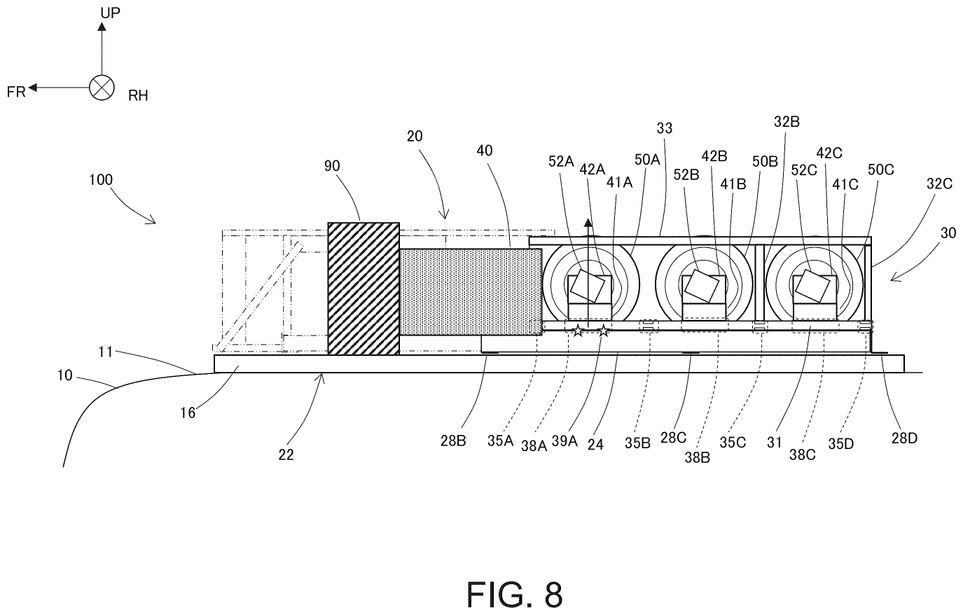

As shown in FIG. 7, when the barrier 90 enters the upper portion of the roof 11 in a swaged manner, the barrier 90 crushes the base frame 22 in front of the radiator 45 and collides with the FC module 40. Then, as shown in FIG. 8, the barrier 90 retracts the FC module 40 while significantly deforming the base frame 22. At this time, the upper end of the first frame column 32A of the frame 30 is largely deformed rearward. At this time, a large bending moment is applied to the bracket 37 to which the first frame column 32A is connected, whereby the bolt 37A is broken. As a result, the bracket 37 is detached from the first fragile portion 35A.

Then, as shown in FIG. 8, the FC module 40 hits the trunk portion of the first hydrogen tank 50A and applies a rearward impact force to the first hydrogen tank 50A. This impact force is applied to the left and right first tank fastening portions 38A via the left and right nozzles 51A. As described above, the load-bearing capacity FW of the welded portion 39 is equal to or less than half of the load-bearing capacity GR in the radial direction of the trunk portion of the first hydrogen tank 50A and equal to or less than the load-bearing capacity GN of the nozzle 51A at the end portion in the longitudinal direction of the first hydrogen tank 50A. Therefore, the plurality of weld beads 39A between the first tank fastening portion 38A and the rear base rail 24 break as indicated by star marks in FIG. 8 before the trunk portion of the first hydrogen tank 50A and the nozzle 51A are largely deformed by the impact force.

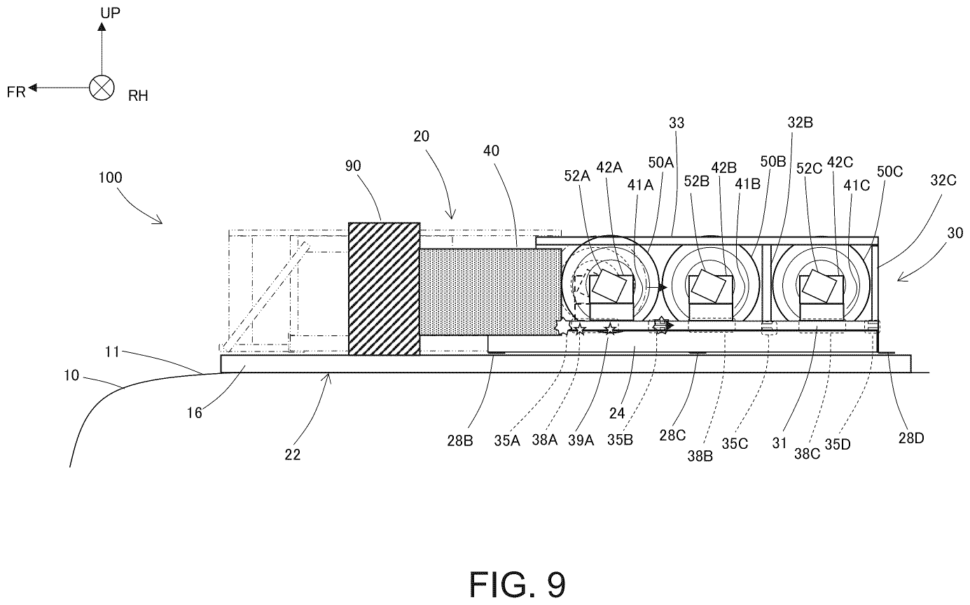

Then, as indicated by an arrow in FIG. 8, the first hydrogen tank 50A floats upward, and the impact force from the first hydrogen tank 50A is applied to the first fragile portion 35A. As described above, the load-bearing capacity FL in the vehicle longitudinal direction of the first fragile portion 35A is equal to or less than half of the load-bearing capacity GR in the radial direction of the trunk portion of the first hydrogen tank 50A and equal to or less than the load-bearing capacity GN of the nozzle 51A at the end portion in the longitudinal direction of the first hydrogen tank 50A. Therefore, the first fragile portion 35A is largely deformed before the first hydrogen tank 50A is largely deformed. Due to the deformation of the first fragile portion 35A, the second fragile portion 35B is also largely deformed, and the bolt 37A of the bracket 37 covering the second fragile portion 35B breaks. Then, as shown by the hexagonal star mark in FIG. 9, the first fragile portion 35A breaks in the front-rear direction, and the second fragile portion 35B collapses in the front-rear direction. As described above, since the plurality of weld beads 39A between the first tank fastening portion 38A and the rear base rail 24 are broken, the first hydrogen tank 50A moves rearward together with the first tank fastening portion 38A.

As described above, the lengths in the front-rear direction of the upper notch 36A and the lower notch 36B of the second fragile portion 35B are larger than the gaps in the front-rear direction of the first and second hydrogen tanks 50A and 50B. Therefore, when the second fragile portion 35B is crushed in the front-rear direction and the first hydrogen tank 50A moves rearward, the first hydrogen tank 50A collides with the second hydrogen tank 50B in the form of a ball. Then, an impact force is applied from the first hydrogen tank 50A to the second hydrogen tank 50B.

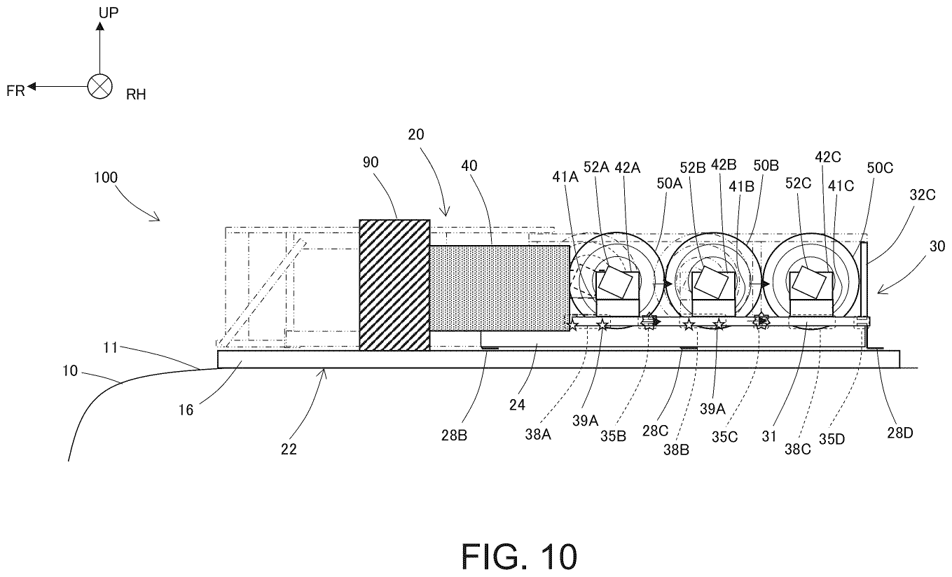

As indicated by star marks in FIG. 10, the plurality of weld beads 39A between the second tank fastening portion 38B and the rear base rail 24 break due to the impact force applied to the second hydrogen tank 50B. Further, when the frame 30 is largely deformed, the second frame column 32B is largely deformed, the bolt 37A of the bracket 37 of the third fragile portion 35C is disengaged, and the third fragile portion 35C is crushed in the front-rear direction. Then, as shown in FIG. 10, the second hydrogen tank 50B retreats together with the second tank fastening portion 38B, the first hydrogen tank 50A, and the first tank fastening portion 38A, and hits against the third hydrogen tank 50C in the form of a ball.

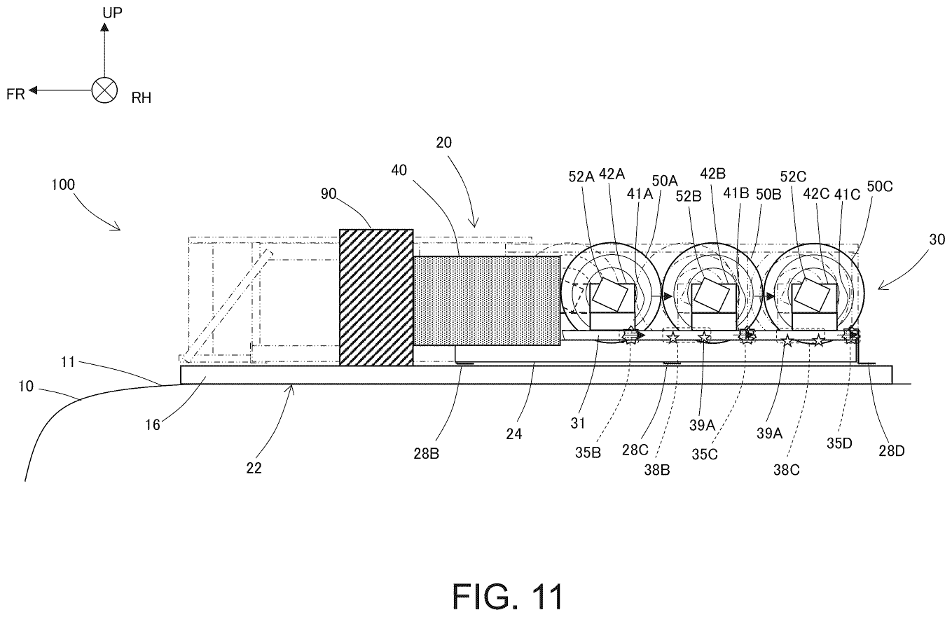

Further, when the barrier 90 enters, as indicated by star marks in FIG. 11, the weld bead 39A of the third tank fastening portion 38 breaks, and the fourth fragile portion 35D is crushed in the front-rear direction. Then, the first to third hydrogen tanks 50A to 50C move rearward together with the first to third tank fastening portions 38A to 38C and are detached from the rear base rail 24.

As described above, since the load-bearing capacity FL of the first to fourth fragile portions 35A to 35D and the load-bearing capacity GW of the welded portion 39 are smaller than the load-bearing capacity GR of the first to third hydrogen tanks 50A to 50C and the load-bearing capacity GN of the nozzles 51A to 51C, the first to fourth fragile portions 35A to 35D and the welded portion 39 are broken or crushed before the first to third hydrogen tanks 50A to 50C or the nozzles 51A are largely deformed. Thus, the first to third hydrogen tanks 50A to 50C can be detached from the rear base rail 24 without damaging the first to third hydrogen tanks 50A to 50C and the nozzles 51A to 51C.

The lengths of the second fragile portion 35B and the third fragile portion 35C in the front-rear direction are longer than the gaps in the front-rear direction of the first and second hydrogen tanks 50A and 50B and the gaps in the front-rear direction of the second and third hydrogen tanks 50B and 50C. Therefore, when the barrier 90 enters, the first to third hydrogen tanks 50A to 50C can be moved rearward while colliding with each other in the front-rear direction in a ball-pushing manner to be detached from the rear base rail 24.

Accordingly, damage to the first to third hydrogen tanks 50A to 50C disposed on the roof due to entry of the barrier 90 can be suppressed.

The bracket 37 is fixed to the upper surface of the side rail 31 by a bolt 37A that can be broken so as to cover the first to fourth fragile portions 35A to 35D. Thus, the strength of the first to third fragile portions 35A to 35D in the normal state can be maintained. Since the bracket 37 is detached by breaking the bolt 37A at the time of collision, the first to fourth fragile portions 35A to 35D are broken or crushed at the time of collision.

In the above description, the power generation unit 20 of the electric vehicle 100 is described as including three gas fuel tanks of the first to third hydrogen tanks 50A to 50C, but the number of gas fuel tanks may be one, two, or four or more.

The power generation unit 20 may have a configuration different from the configuration described above. For example, a total of six fragile portions may be provided, one for each of the front and rear of the first to third tank fastening portions 38A to 38C. In addition, only the first fragile portion 35A on the front side of the first tank fastening portion 38A and the fourth fragile portion 35D on the rear side of the third tank fastening portion 38C may be provided, and the second and third fragile portions 35B and 35C may not be provided.

In the power generation unit 20, instead of the upper notch 36A and the lower notch 36B, a plurality of small notches or holes may be arranged in the front-rear direction, and the total length of the notches or holes in the front-rear direction may be longer than the gaps of the first to third hydrogen tanks 50A to 50C.

In addition, in the power generation unit 20, for example, the welding portion 39 may be configured by a plurality of spot welding. Further, the first to third tank fastening portions 38A to 38C may be fixed to the rear base rail 24 by a configuration other than welding. For example, the first to third tank fastening portions 38A to 38C may be fixed to the rear base rail 24 by a plurality of bolts. At this time, the size of the bolt may be set so that the sum of the shear fracture loads of the plurality of bolts is smaller than the load-bearing capacity GR of the first to third hydrogen tanks 50A to 50C and the load-bearing GN of the nozzles 51A to 51C. Accordingly, before the first to third hydrogen tanks 50A to 50C and the nozzles 51A to 51C are largely deformed, the bolts are broken, and the first to third tank fastening portions 38A to 38C can be detached from the rear base rail 24.

Further, although the bracket 37 has been described as being fixed to the side rail 31 by the bolt 37A which is a fastening member, it is not limited to the bolt 37A and may be fixed to the side rail 31 by, for example, a rivet or a clip as long as it is fixed by a frangible fastening member. The bolt 37A may be provided with a notch so as to be easily broken.

1. An electric vehicle comprising:
left and right side rails mounted on a roof and extending in the vehicle front-rear direction,
at least one gas fuel tank that is a cylindrical longitudinal member and is fastened to the left and right side rails at both ends in a longitudinal direction thereof,
each of the left and right side rails includes at least one fragile portion in which a load-bearing capacity in the vehicle front-rear direction is equal to or less than a load-bearing capacity of the gas fuel tank.

2. The electric vehicle according to claim 1, wherein
each of the left and right side rails includes at least one tank fastening portion to which an end portion of the gas fuel tank is fastened,
the fragile portion is provided at one or both of a front side and a rear side of the tank fastening portion,
the load-bearing capacity of the fragile portion in the vehicle front-rear direction is equal to or less than half of the load-bearing capacity of the trunk portion of the gas fuel tank in the radial direction and equal to or less than the load-bearing capacity of the end portion of the gas fuel tank.

3. The electric vehicle according to claim 2, further comprising:
left and right base rails mounted on the roof and extending in the vehicle front-rear direction,
wherein the left and right side rails are disposed on upper surfaces of the left and right base rails, and the left and right tank fastening portions are fixed at a fixing portion on upper surfaces of the left and right base rails,
a load-bearing capacity of the fixing portion in the vehicle front-rear direction is equal to or less than half of a load-bearing capacity of the trunk portion of the gas fuel tank in the radial direction and equal to or less than a load-bearing capacity of the gas fuel tank in the end portion.

4. The electric vehicle according to claim 3, wherein
the fixing portion includes a plurality of weld beads,
a total of load-bearing capacities of the plurality of weld beads in the vehicle front-rear direction is equal to or less than half of a load-bearing capacity of the trunk portion of the gas fuel tank in the radial direction and equal to or less than a load-bearing capacity of the end portion of the gas fuel tank.

5. The electric vehicle according to claim 2, further comprising:
a plurality of brackets fixed to an upper surface of each of the left and right side rails by a plurality of fastening members, each of the plurality of brackets covering each of the fragile portions,
wherein each of the plurality of the fastening members is rupturable upon impact.

6. The electric vehicle according to claim 3, further comprising:
a plurality of brackets fixed to an upper surface of each of the left and right side rails by a plurality of fastening members, each of the plurality of brackets covering each of the fragile portions,
wherein each of the plurality of the fastening members is rupturable upon impact.

7. The electric vehicle according to claim 3, wherein
the at least one gas fuel tank includes a plurality of gas fuel tanks,
a length of each of the at least one fragile portion in the vehicle front-rear direction is longer than a gap between the plurality of gas fuel tanks in the vehicle front-rear direction.

8. The electric vehicle according to claim 4, wherein
the at least one gas fuel tank includes a plurality of gas fuel tanks,
a length of each of the at least one fragile portion in the vehicle front-rear direction is longer than a gap between the plurality of gas fuel tanks in the vehicle front-rear direction.
